(19) United States
(12) Patent Application Publication
(10) Pub. No.: US 2016/0027606 A1
(43) Pub. Date: Jan. 28, 2016

(54) ARRANGEMENT FOR A QUICK ELECTRON BEAM X-RAY COMPUTER TOMOGRAPHY

(71) Applicant: HELMHOLTZ-ZENTRUM DRESDEN-ROSSENDORF E.V., Dresden (DE)

(72) Inventor: Frank BARTHEL, Dresden (DE)

(21) Appl. No.: 14/781,404

(22) PCT Filed: Apr. 2, 2014
(86) PCT No.: PCT/DE2014/000160

§ 371 Date: Sep. 30, 2015

(30) Foreign Application Priority Data
Apr. 9, 2013 (DE) 10 2013 206 252.4

(51) Int. Cl. H01J 35/14; H01J 35/08; H05G 1/02

(52) U.S. Cl. CPC H01J 35/14; H05G 1/02; H01J 35/08

(57) ABSTRACT

A system for electron beam X-ray computer tomography, which requires no considerable axial extension of the electron emitter and substantially eliminates electron-optical beam guidance elements is provided by disposing an X-ray detector arc and the target around the examination cross-section within an irradiation plane, and radially introducing an electron beam generated in the electron beam generator into the magnetic flux region of one or more longitudinal coils from within or outside the coils and forcing the same onto a circular path by way of the magnetic field. By periodically changing the field strength, the radius of the circular path is increased, as a result of which the electron beam impinges on the target in a tangentially migrating focal spot. Radiography projections of the object located in the center of the system are recorded by the X-ray detector surrounding the target, the target and x-ray detector planes being with or without axial offset.

### BACKGROUND OF THE INVENTION

The invention relates to a system for electron beam X-ray computer tomography. Electron beam X-ray computer tomography has been used for several years in medical diagnostics, for example, in particular for imaging the beating heart, or in process tomography to generate image sequences of sections of flow processes with very high temporal and local resolutions.

For this purpose, an electron beam that is guided in a vacuum chamber is guided across a circular segment-shaped metal target using an electromagnetic deflection system, whereby a rapidly moving X-ray focal spot is generated. A circular-shaped or circular segment-shaped X-ray detector disposed with slight axial offset in relation to the target detects the X-rays transmitted through the object. The measurement data can then be used to calculate the density distribution in the radiographed cutting plane using tomographic image reconstruction methods.

U.S. Pat. No. 4,352,021 A describes such a system, in which the electron beam is guided starting from a static electron gun In the axial direction at the target. Due to the limited deflection angle of the deflection coil packet that is possible in the system described in U.S. Pat. No. 4,352,021 A, a considerable axial distance is necessary between the electron gun and the image plane to achieve a focal spot path having a meaningful diameter. This results in greater complexity in beam shaping and guidance, and thus increases the complexity for the vacuum pump system due to the large recipient volume and limits the size of the objects to be analyzed in the axial direction. Moreover, this system limits the possible projection angle for tomographic scans since the electron beam and object are partially in each other's path. The same applies to US 2003/0161434. DE 10 2007 008 349 A1 describes a system for rapid axial offset-free scans, which can be used in process tomography. Here too, the above-described restrictions apply and increase the technical complexity. At the same time, the shape of the electron beam guided close to the target obliquely from an axial direction necessitates a minimum distance between the electron beam X-ray computer tomography system and flanges, fittings and similar radially projecting components when analyzing flows in pipelines. This results in significant limitations In the selection of possible examination objects and locations, and thus in limitations on usability.

### SUMMARY OF THE INVENTION

It is the object of the present invention to provide a system for X-ray computer tomography in which the above-mentioned deficiencies are reduced.

The object is achieved by considerably reducing the axial size of the electron beam X-ray computer tomography system, so that this system does not require complex beam shaping and guidance systems. In this way, the angular range of radiography is increased.

One or more longitudinal coils are used in the system according to the invention to force an electron beam that is injected in the direction of the main planes of the coils onto a circular path in the magnetic field of the coils.

A bremsstrahlung target and a detector ring are located on the circumference of the coil pair. By periodically lowering and increasing the intensity of the magnetic field, the radius of the circular path of the electron beam is cyclically varied, whereby it collides with, the target wall resulting in a focal spot migrating in a circular fashion along the target, and thus leading to a bremsstrahlung source spot rotating around the longitudinal axis of the system. The object runs through the longitudinal axis of the system.

The primary advantage of the inventive system for X-ray computer tomography is that the system requires little axial installation space, whereby it can also be used for non-contact measurements under spatial constraints and close to fittings and flanges. Moreover, this system achieves a very large projection angle, which allows the artifact-free reconstruction of objects having large diameters in relation to the target/detector diameter. It is advantageous that the system according to the invention requires no complex beam shaping and guidance systems and is therefore robust in operation.

The system according to the invention comprises:

a) an electron beam generator (1), which is disposed within a vacuum chamber (2);

b) one or more longitudinal coils (3) for radially deflecting the electron beam;

c) one or more targets (4) disposed within the vacuum chamber for braking the electron beam (5) and for generating X-ray bremsstrahlung; and

d) at least one circular segment-shaped or full circle-shaped X-ray detector arc (6) made of individual detectors linked together;

wherein

e) the electron beam generator (1) is disposed so that the electron beam (5) generated can be radially injected in the direction of the main planes of the coils;

f) one or more bremsstrahlung targets (4) are concentrically disposed in the region of the circumference of the longitudinal coils (3);

g) the X-ray detector arc (6) is located within or outside the target radius; and

h) the X-ray detector plane is disposed either with or without axial offset in relation to the target plane.

The longitudinal coils can be disposed within or outside the vacuum chamber, if the longitudinal coils are disposed outside the vacuum chamber, the outside wail of the vacuum chamber (2) is advantageously made of a diamagnetic material.

Advantageously, thin longitudinal coils are used. Thin longitudinal coils within the meaning of the invention are coils having only one or a small number of windings, which is to say the diameter is significantly larger than the length of the coil.

In one embodiment variant, the X-ray defector arc (8) is disposed outside the vacuum chamber (2), wherein the vacuum chamber (2) is then advantageously made of a thin-walled material, which ensures minimal weakening of the X-rays.

A special embodiment variant enables synchronous multi-plane tomography. In this variant, the electron beam generator (1), the target (4) and the X-ray detector arc (6) are multiply disposed, ideally on top of each other, in the axial direction. The longitudinal coil has a corresponding axial extension, or multiple longitudinal coils are used.

Ideally, the bremsstrahlung target (4), when the same is disposed in front of the X-ray detector arc (6), is made of a material having low density, and a thin X-ray conversion layer made of a material having a high atomic number is applied to the inside of the bremsstrahlung target (4).

The target surface may be designed in a tooth-like structured manner in a further embodiment variant.

The electron beam generator (1) can be disposed either within or outside the longitudinal coils (3). If the electron beam generator (1) is disposed outside the longitudinal coils (3), the electron beam is injected through an axial gap between the longitudinal coils into the magnetic flux region.

Advantageously, the longitudinal coils are used in pairs.

The invention will be described in more detail hereafter using exemplary embodiments shown schematically in the accompanying drawings.

### BRIEF DESCRIPTION OF THE DRAWINGS

FIGS. 1 and 2 show an overall system having a beam generator located on the inside, FIG. 2 being a cross-section on line II-II of FIG. 1; and

FIGS. 3 and 4 show an overall system having a beam generator located on the outside, FIG. 4 being a cross-section on line IV-IV of FIG. 3.

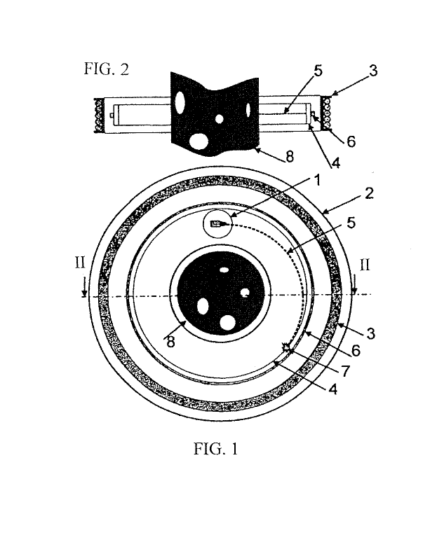

FIGS. 1 to 4 show two exemplary embodiments of the system, in both cases, the system comprises an annular target (4) and an X-ray detector arc (8), which is disposed outside the target (4) and can be made of individual detectors that are linked together. The X-ray detector arc (8) may be disposed either without or with small axial offset in relation to the target (4).

FIGS. 1 and 2 show an embodiment in which the electron beam generator (1) is located within the longitudinal coils (3).

### DETAILED DESCRIPTION OF THE INVENTION

The electron beam (5) is generated within the vacuum chamber (2) by the electron beam generator (1) and forced onto a circular path in the magnetic flux region of the longitudinal coils (3) by the Lorentz force. By periodically varying the coil current, and thereby varying the intensity of the magnetic field, the radius of the circular path of the electron beam (5) is varied, whereby the electron beam (5) impinges on the target (4) at a focal spot (7) migrating on a circular path and emitting bremsstrahlung. The object (8) to be analyzed, radiography projection data sets for which are recorded from different projection angles by the detector arc (8), is located at the center of the system outside the vacuum chamber (2).

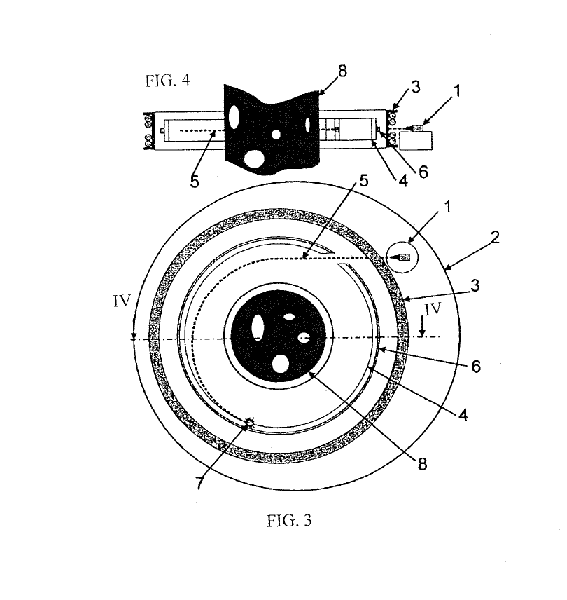

In the embodiment shown in FIGS. 3 and 4 the electron beam generator (1) is located outside the longitudinal coils (3) and runs through an axial gap between these longitudinal coils (3) into the magnetic flux region. The advantage of this system is that the electron beam generator that is used can be easily replaced.

1. A system for electron beam X-ray computer tomography, comprising:
a) an electron beam generator for generating an electron beam, wherein the electron beam generator is disposed within a vacuum chamber;
b) one or more longitudinal coils for generating a coil magnetic field to radially deflect the electron beam;
c) one or more bremsstrahlung targets for braking the electron beam and for generating X-ray bremsstrahlung, the bremsstrahlung targets being disposed in the vacuum chamber concentrically thereto in a region of a circumference of the longitudinal coils; and
d) at least one circular segment-shaped or full circle-shaped X-ray detector arc;
wherein
e) the system is configured so that the electron beam is injected in a direction of main planes of the longitudinal coils in such a way that the electron beam is forced onto a circular path in the coil magnetic field; and
f) for the purpose of periodically lowering and increasing intensity of the magnetic field of the longitudinal coils so as to vary a radius of the circular path of the electron beam, the system is configured so that the election beam impinges on the bremsstrahlung targets; in a focal spot migrating on a circular path.

2. The system according to claim 1, wherein the X-ray detector arc is disposed outside the vacuum chamber.

3. The system according to claim 1, wherein the longitudinal coils are enclosed in the vacuum chamber.

4. The system according to claim 1, wherein the longitudinal coils are disposed outside the vacuum chamber, the vacuum chamber being made of a diamagnetic material.

5. The system according to claim 1, wherein the diameter of each of the longitudinal coils is greater than the respective lengths thereof.

6. The system according to claim 1, comprising a plurality of at least one of the electron beam generator, the target or the X-ray detector are disposed in an axial direction, the longitudinal coils extending across a corresponding axial extension, thereby enabling synchronous multi-plane tomography possible.

7. The system according to claim 1. wherein, the bremsstrahlung target is located in front of the X-ray detector arc.

8. The system according to claim 1, wherein the target surface is of a tooth-like configuration.

9. The system according to claim 1, wherein the electron beam generator is located within the longitudinal coils.

10. The system according to claim 1, wherein the electron beam generator is disposed outside the longitudinal coils, the electron beam being injected through an axial gap between the longitudinal coils into a magnetic flux region of the longitudinal coils.
